(19) United States
(12) Patent Application Publication
(10) Pub. No.: US 2013/0073059 A1
(43) Pub. Date: Mar. 21, 2013

(54) USER INTERFACE FOR DETERMINING RESOURCE CONSUMPTION

(71) Applicants: Joseph Mark Brian, Louisville, KY (US); David C. Bingham, Louisville, KY (US); Rich Merwarth, Louisville, KY (US)

(72) Inventors: Joseph Mark Brian, Louisville, KY (US); David C. Bingham, Louisville, KY (US); Rich Merwarth, Louisville, KY (US)

(21) Appl. No.: 13/237,239

(22) Filed: Sep. 20, 2011

(51) Int. Cl. G05B 15/02

(52) U.S. Cl. 700/17; 700/1

(57) ABSTRACT

A resource consumption user interface is disclosed comprising one or more user input features for selecting a start date and an end date for defining a selected time range over which to determine resource consumption associated with at least one resource consumption task from a plurality of resource consumption tasks that contribute to a total resource consumption in a given environment. The plurality of resource consumption tasks are associated with one or more appliances that operate in the given environment. The start date and the end date are selectable for any desired time range over a given time duration. The resource consumption user interface also comprises one or more user output features for presenting information associated with the at least one resource consumption task, wherein the presented information represents accumulated information beginning at a time on the selected start date and ending at a time on the selected end date.

### CROSS-REFERENCE TO RELATED APPLICATION

The present application is related to the U.S. patent application identified by attorney docket no. 249274, entitled “User Interface for Monitoring Resource Consumption,” filed concurrently herewith, the disclosure of which is incorporated by reference in its entirety herein.

### BACKGROUND OF THE INVENTION

The subject matter disclosed herein relates to resource consumption, and more particularly to a resource consumption user interface.

Resource consumption, for example, energy consumption, particularly in a home environment, is receiving increased consideration in view of the ever-growing realization that energy resources are not limitless. Cost, pollution, and potential for climate change are also very strong reasons for evaluating energy consumption.

Energy consumption attributable to a home is typically monitored via one or more energy meters installed at the home. Such an energy meter measures the overall amount of a particular form of energy that is supplied to the home.

For example, an electric meter installed on the electric input line to a given home keeps track of the number of kilowatt-hours (kWh) that are supplied to, and thus consumed by, the given home. Unfortunately, there is no way for the occupant/owner of the home to determine how much of that energy consumption is attributed to specific loads or the entire home over a given time range in an ad-hoc manner.

### BRIEF DESCRIPTION OF THE INVENTION

As described herein, the exemplary embodiments of the present invention overcome one or more disadvantages known in the art.

One aspect of the present invention relates to a resource consumption user interface comprising one or more user input features for selecting a start date and an end date for defining a selected time range over which to determine resource consumption associated with at least one resource consumption task from a plurality of resource consumption tasks that contribute to a total resource consumption in a given environment. The plurality of resource consumption tasks are associated with one or more appliances that operate in the given environment. The start date and the end date are selectable for any desired time range over a given time duration. The resource consumption user interface also comprises one or more user output features for presenting information associated with the at least one resource consumption task, wherein the presented information represents accumulated information beginning at a time on the selected start date and ending at a time on the selected end date.

Another aspect of the invention relates to a resource consumption system comprising a user interface which comprises: (i) one or more user input features for selecting a start date and an end date for defining a selected time range over which to determine resource consumption associated with at least one resource consumption task from a plurality of resource consumption tasks that contribute to a total resource consumption in a given environment, wherein the plurality of resource consumption tasks are associated with one or more appliances that operate in the given environment and wherein the start date and the end date are selectable for any desired time range over a given time duration; and (ii) one or more user output features for presenting information associated with the at least one resource consumption task, wherein the presented information represents accumulated information beginning at a time on the selected start date and ending at a time on the selected end date. The resource consumption system also comprises a controller coupled to the user interface and configured to: (i) receive one or more selections from the one or more user input features; and (ii) in response thereto, provide the information to the one or more user output features for presentation.

In one or more embodiments, the resource may comprise an energy resource such as electricity or natural gas. However, in one or more alternative embodiments, the resource may comprise water.

Advantageously, illustrative principles of the present invention provide for an occupant/owner of the home to determine, in an ad-hoc manner, how much resource consumption occurred during any range of time within a given time period for which they desire to obtain this information. Given a realization of this specific information, an occupant/owner can adjust his/her resource usage patterns in order to reduce resource consumption.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 is a diagram of a home energy system, in accordance with an embodiment of the invention;

FIG. 2 is a diagram of exemplary views of an energy consumption user interface, in accordance with an embodiment of the invention;

FIG. 3 is a diagram of an energy consumption determination algorithm, in accordance with an embodiment of the invention; and

FIG. 4 is a diagram of further exemplary views of an energy consumption user interface, in accordance with an embodiment of the invention.

### DETAILED DESCRIPTION OF THE EXEMPLARY EMBODIMENTS OF THE INVENTION

One or more of the embodiments of the invention will be described below in the context of energy consumption (as an example of resource consumption) in association with appliances in a home or household environment. However, it is to be understood that principles of the invention are not intended to be limited to use in home or household environments or with any particular appliances. Rather, principles of the invention may be applied to and deployed in any other suitable environment in which it would be desirable to improve the monitoring of energy (resource) consumption.

As illustratively used herein, the term “appliance” is intended to refer to a device or equipment designed to perform one or more specific functions. This may include, but is not limited to, equipment for consumer use, e.g., a refrigerator, a cooking range, a laundry washer, a laundry dryer, a dishwasher, a microwave oven, water heaters, etc. This may include, but is not limited to, any equipment that is useable in household or commercial environments.

As used herein in illustrative embodiments, appliances include, but are not limited to, equipment that runs on electricity as an energy source. That is, other sources of energy other than electric may be monitored and analyzed in accordance with an energy consumption user interface formed in accordance with illustrative principles of the invention. For example, one or more embodiments of the invention can be applied to determine natural gas consumption. More generally, embodiments of the invention can be applied to resource consumption and not just energy consumption. For example, water consumption can be monitored and analyzed using one or more embodiments of the invention. That is, for alternate resource consumption embodiments, the system would just be monitoring and reporting different units instead of kWh, for instance, gallons in the case of water or cubic feet in the case of natural gas. However, for clarity and consistency of explanation, the illustrative embodiments of the invention are described below in the context of energy consumption in the form of electricity in kWh.

As illustratively used herein, the phrase “user interface” is intended to refer to an area where interaction between a human and a machine occurs including but not limited to a user viewing or listening to some form of information presented by the machine and/or the user inputting one or more selections or commands to the machine. In at least some of the appliance embodiments described herein, the machine is the appliance and the human is the user or consumer, and interaction between the user and the appliance is via a user interface.

Illustrative principles of the invention provide apparatus, systems and methods that allow the homeowner to examine energy consumption and cost information in an ad-hoc manner. That is, the homeowner is able to examine energy and cost data for specific periods that are unique to his/her circumstances. To do this, the homeowner is allowed to select two dates via a calendar feature on a user interface, and the system reports to the homeowner how much energy was consumed, and at what cost, between those two dates (in one embodiment, inclusive of endpoints). The energy analysis may be done on any metered device, including a whole-home electricity analysis, as well as individual loads (e.g., individual appliances or tasks) in the home.

By way of example only, in a home environment, the homeowner may have been on vacation the week before and would like to know how much energy was used in the house (i.e., whole-home energy consumption) and how much did it cost for that week when the house was dormant. This information could be compared to a normal week when the homeowner was at home. An energy consumption user interface and energy consumption determination algorithm according to an illustrative embodiment of the invention would provide this comparative information.

By way of another example, again in a home environment, the homeowner may realize that his/her utility billed him/her for 1200 kWh the prior month. The homeowner may want to know whether or not his/her system reflects that same usage (i.e., again, whole-home energy consumption). An energy consumption user interface and energy consumption determination algorithm according to an illustrative embodiment of the invention would provide this confirmatory information.

By way of yet another example, once again in the home environment, the homeowner may have decided that he/she wishes to try and save energy by adjusting his/her thermostat set point. Thus, the homeowner lets the system run for one week with the thermostat at 70 degrees, and then the next week moves it up 72 degrees. The homeowner would thus be interested in learning the difference in the home energy consumption and cost for those two weeks. An energy consumption user interface and energy consumption determination algorithm according to an illustrative embodiment of the invention would provide this comparative information.

By way of yet a further example, the homeowner may want to know how much he/she spent on energy when operating a particular appliance over a given period of time. In accordance with an energy consumption user interface and energy consumption determination algorithm according to an illustrative embodiment of the invention, the homeowner can obtain an accurate indication of the energy consumption and cost.

In accordance with an energy consumption user interface and energy consumption determination algorithm according to an illustrative embodiment of the invention, a database is maintained that contains historical energy consumption and cost information, for example, one hour resolution (or some other time resolution) energy usage and cost information that spans back three years for a monitored facility such as a home or a monitored appliance such as a laundry dryer (or one or more other home appliances). Thus, as each hour passes, the energy consumption determination algorithm writes new values for energy usage and cost to the database.

As will be explained in an illustrative embodiment below, a person accesses the energy consumption function through a user interface and selects start date and end date features (e.g., touchscreen-activated button) on the user interface. The energy consumption determination algorithm then calculates energy and cost information for that given time range.

For example, the user is presented with a calendar feature and the option to select a start date and an end date defining a time range over which the energy analysis is to be performed. It is to be understood that the start date and the end date can be different dates or, if the time range of interest is a single day, the start date and the end date could be the same date. Once the user has specified the start and end dates, the algorithm calculates the energy usage and cost starting, for example, at midnight on the first date, and ending at midnight on the second date with one hour resolution. The algorithm is also configured to deal with partial data. For example, if the end date is today and it is only 6:30 PM, the algorithm will only count the first 18 hours of the day, up through 6 PM which is the most recent hour boundary.

The energy usage (e.g., in kilowatt-hours) and cost (e.g., in dollars and cents) is presented to the person through a display feature on the user interface. Both energy units and cost units can be displayed together, or a person may select which unit to display via a unit selection feature (e.g., button) on the user interface.

It is to be appreciated that the user interface may have other user input features for selecting other functionalities and other user output features for presenting information.

Advantageously, in accordance with illustrative embodiments of the invention, a person is able to track energy use and cost for his/her entire home or for any individual appliances or tasks within the home in an ad-hoc manner, i.e., for any desired time range over a given time duration.

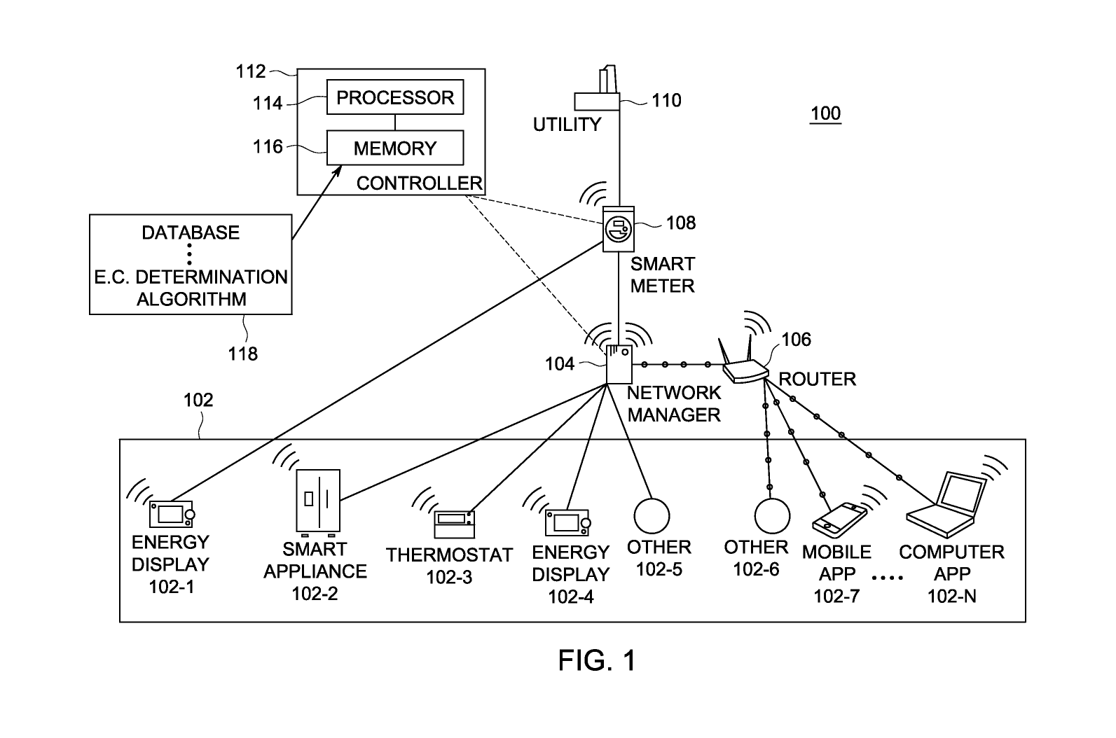

FIG. 1 is a diagram of a home energy system, in accordance with an embodiment of the invention. As shown, home energy system 100 comprises one or more devices 102 upon which an energy consumption user interface according to an embodiment of the invention may be implemented. It is to be appreciated that some of the devices 102 are coupled to a network manager 104, a router 106, or a smart meter 108 (a “smart meter” is generally known to be a device, e.g., an electric meter, able to, inter alia, measure and communicate the amount of energy supplied to a given environment).

For example, an energy consumption user interface may be implemented on an energy display 102-1 coupled to the smart meter 108. Further as shown, an energy consumption user interface may be implemented on a smart appliance 102-2, a thermostat 102-3, an energy display 102-4, or some other device 102-5 coupled to the network manager 104. Similarly, an energy consumption user interface may be implemented on a device 102-6, as an application on a mobile phone 102-7, or as an application on a computer device 102-N coupled to the router 106.

It is to be appreciated that embodiments of the invention are not limited to the manner in which the devices 102 are coupled to the network manager 104, the router 106, or the smart meter 108. By way of example only, device 102-1 may be coupled to the smart meter 108 by a Zigbee wireless protocol connection (denoted in FIG. 1 as a solid line). Devices 102-2 through 102-5 may be coupled to the network manager 104 in the same manner. Devices 102-6 through 102-N are coupled to the router 106 via an Ethernet or Wifi wireless protocol connection (denoted in FIG. 1 as a solid line with dots). The router 106 and the network manager 104 may be coupled to one another via the same type of connection.

Also shown in FIG. 1 is a utility 110 which is coupled to the smart meter 108 via some other form of connection (denoted in FIG. 1 as a solid line with x's). Such a connection may be wireless, wired, or some combination thereof.

Note also that the network manager 104 and the smart meter 108 each are configured with a controller 112, which includes a processor 114 and memory 116. It is to be understood that the energy consumption determination algorithm, mentioned above, may be stored in the memory 116, and when ready to be executed, loaded into processor 114 and executed. This is also where the database, mentioned above, may be stored and accessed. The energy consumption database and energy consumption determination algorithm are illustratively depicted as 118 in FIG. 1. It is to be appreciated that, alternatively, the energy consumption determination algorithm and/or the energy consumption database could be stored and executed by a controller (processor/memory) resident in one or more of the devices 102. Also, a standalone dedicated controller (not expressly shown) could be employed to store and execute the database and/or algorithm.

The phrase “smart appliance” is intended to generally refer to an appliance, e.g., a household refrigerator, dishwasher, laundry washer, laundry dryer, etc., that is able to, inter alia, provide operational data, e.g., energy consumption, to a network controller (e.g., network manager 104). For example, a smart appliance is disclosed in application Ser. No. 12/899,986, filed Oct. 7, 2010, attorney docket no. 241578, the disclosure of which is incorporated herein by reference in its entirety.

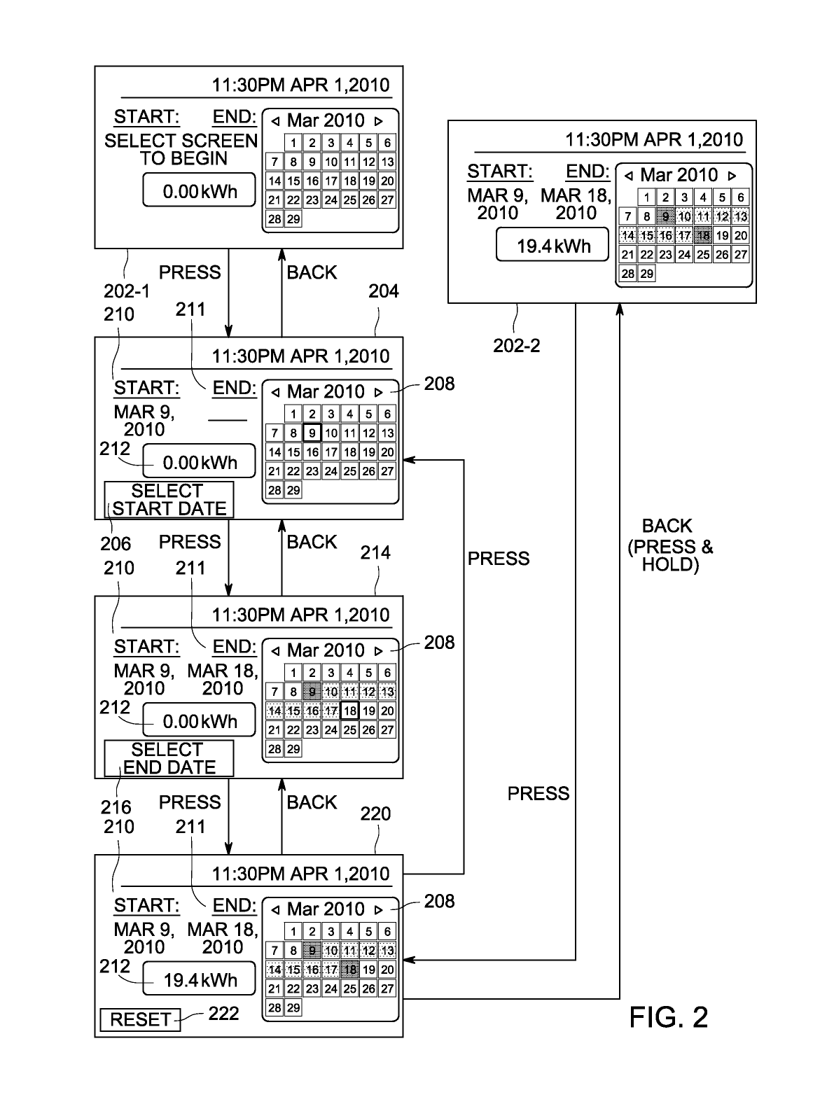

FIG. 2 is a diagram of exemplary views of an energy consumption user interface, in accordance with an embodiment of the invention. As shown in the figure, a sequence of views of an energy consumption user interface 202 is illustrated from a point before a selected start date (202-1) through to a view of the user interface after the energy consumption information is computed and presented to the user (202-2).

It is assumed that the user interface is implemented to determine energy consumption associated with at least one energy consumption task from a plurality of energy consumption tasks that contribute to a total energy consumption in a given environment, wherein the plurality of energy consumption tasks are associated with one or more appliances that operate in the given environment. By way of example only, the user interface 202 could be associated with a laundry dryer in a home/residence for which the user wishes to learn how much energy was used to dry laundry over a particular one week period of interest to the user. The user would set the start and end dates, and the system would compute the accumulated appliance energy usage and cost information over that time range and then display the results to the user. Note that the user interface may also be designed to permit the user to select an appliance to monitor (rather than the user interface being dedicated to any specific appliance). Also, as mentioned above, the user interface is capable of displaying energy consumption information to the user over the desired time range for the entire home (whole-home energy consumption).

In this illustrative embodiment, energy consumption user interface view 202 is considered a home screen. The energy consumption user interface home screen can be selected and displayed on one of the displays associated with one of the devices 102 in FIG. 1. It is also to be understood that, in an illustrative embodiment, the display upon which the user interface is presented is touchscreen-capable, i.e., a user is able to touch an icon or area on the screen (user input feature) to make/activate a selection. Any suitable type of touchscreen technology can be employed. Other methods of inputting user selection may be employed, e.g., mouse/cursor selection and keyboard entry. Furthermore, in an energy consumption user interface according to an illustrative embodiment of the invention, information is displayed to the user in other icons or areas on the screen (user output features).

Note that the user may go between home screen views 202 and intermediate screen views 204, 214 and 220 shown in FIG. 2 by pressing the screen of the user interface at a given area. For example, the user may view the intermediate screens by pressing “enter” and “back” keys on the display.

As specifically depicted in view 204 (assumed to be displayed to the user upon the user touching the home screen view 202-1), the user interface comprises a select start date instruction window 206, a calendar window 208, a start date window 210, an end date window 211, and an energy consumption display window 212.

The user then selects a start date in the calendar window (e.g., in this illustration, Mar. 9, 2010) by either touching the date on the calendar or using a pointing device to select the date. Note also that the calendar 208 has arrowheads by the month so that the user can scroll back and forth month-by-month over the given time duration for which the system maintains energy consumption information (e.g., in one illustrative embodiment, this could be three years, but principles of the invention are not limited to any particular time duration). The selected start date is displayed in the start date window 210. The start date is also highlighted on the calendar 208 (e.g., the date is boxed and/or changes color).

Once the start date is selected, the user interface displays view 214 which replaces the select start date information window 206 (of view 204) with a select end date information window 216. The user then selects the end date (e.g., in this illustration, Mar. 18, 2010) in a similar manner as the start date was selected, and the system displays the end date in the end date window 211 and highlights it in the calendar 208. Note also that each day of the time range defined by the start date and the end date may be highlighted as shown (e.g., shaded or colored).

Once the end date is selected, the system calculates the energy usage and cost (energy consumption information) for the appliance, task, or entire home (whole-home) depending on what the user wishes to analyze. As shown in view 220, the resulting energy consumption information over the given range is displayed to the user in window 212.

Also note that, in view 220, a reset button 222 is displayed. The reset button allows the user to purge the previous displayed information, and start the energy consumption determination process again. Alternatively, the user may press and hold his/her finger in a given area of the screen to retain the presented information (as shown in view 202-2).

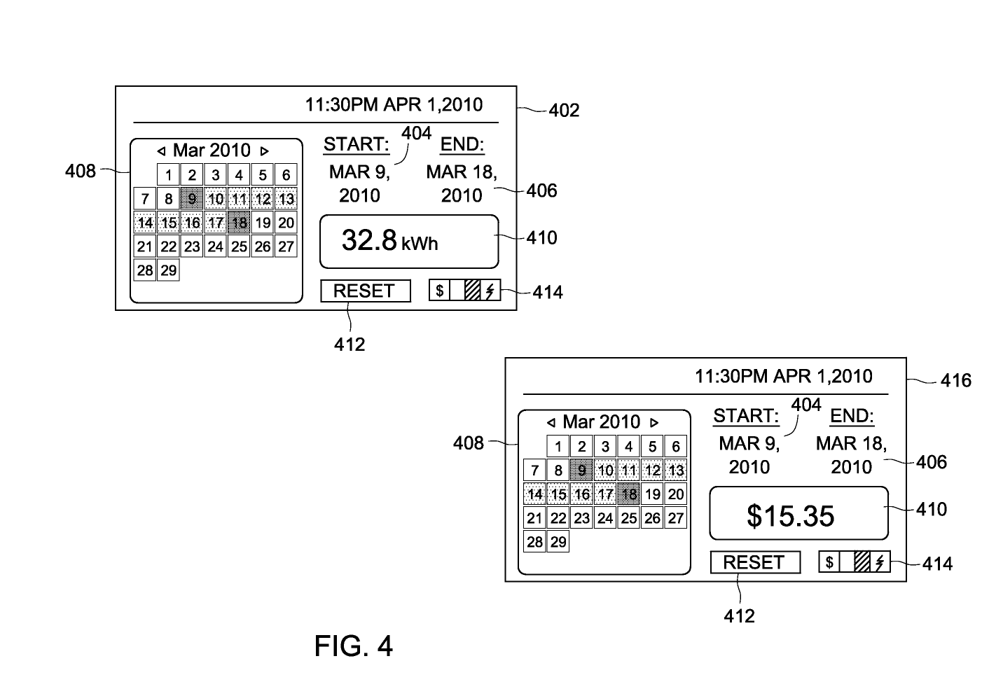

Thus, in this given example, it is noted that the appliance task that the energy consumption user interface analyzed consumed 19.4 kWh over the time range of ten days from (and including) Mar. 9, 2010 through Mar. 18, 2010. As will be seen in the context of FIG. 4, the user can select a cost unit feature to display the cost associated with this amount of energy consumption.

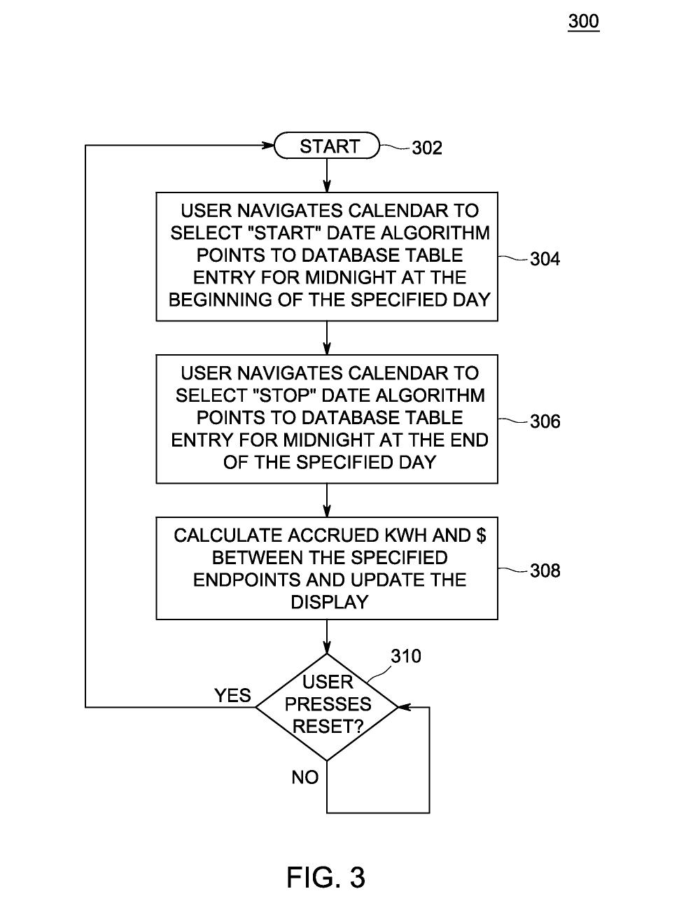

FIG. 3 is a diagram of an energy consumption determination algorithm, in accordance with an embodiment of the invention. Recall that, in accordance with an energy consumption user interface and energy consumption determination algorithm according to an illustrative embodiment of the invention, a database is maintained that contains, for example, one-hour resolution (or some other time resolution) energy usage and cost information over a given time duration, for example, three years (or some other time duration) for a monitored facility or a monitored appliance. The algorithm 300 in FIG. 3 depicts how the information that gets displayed in the user interface (FIG. 2) is generated and from what information it is processed. The algorithm starts at block 302.

In step 304, it is assumed that the user navigates the calendar (e.g., feature 208 in FIG. 2) in the user interface to select a start date. The start date may be any valid date in the database for which there is valid data. The user may not select a date that is “out of bounds” such as a date in the future. The algorithm, in step 304, points to the database entry for midnight at the beginning of the specified start date.

Then, in step 306, it is assumed that the user navigates the calendar in the user interface to select an end date. The end date may be any valid date in the database for which there is valid data. Again, this date should be within the range of valid database data. The algorithm, in step 306, points to the database entry for midnight at the end of the specified end date.

In step 308, the algorithm calculates accrued energy usage (kWh) and accrued cost ($) between the specified start date and end date, and updates the information presented on the user interface (e.g., in energy consumption display window 212 in FIG. 2). In one embodiment, the algorithm looks at the one-hour resolution database table for the two dates in question. A calculation is made to determine total kWh consumed and total money spent from midnight beginning at the oldest date to midnight at the end of the most recent date. This information is then written to the display.

Thus, for example, the algorithm 300 computes an accumulated energy usage value as a difference between an energy usage at midnight at the beginning of the selected start date and an energy usage at midnight at the end of the selected end date. Recall that if the end date is the current date, and thus midnight is still in the future, the algorithm will point to the last hourly entry in the database for the current date to do the calculation. An accumulated energy cost value is calculated in a similar manner (e.g., as a difference between an energy cost at the given time on the selected end date and an energy cost at the given time on the selected start date).

In step 310, if the user presses the reset button (e.g., 222 in FIG. 2), the database pointers are reset and the previous calculations are purged from the user interface. The algorithm is then ready to start again when the user makes new selections. If the reset button is not pushed, the information remains displayed on the user interface.

FIG. 4 is a diagram of further exemplary views of an energy consumption user interface, in accordance with an embodiment of the invention. More particularly, FIG. 4 shows the energy consumption unit selection feature for selecting whether information on the user interface is presented in energy units (kWh) or cost units (dollars and cents).

In view 402, the user interface comprises a start date window 404, an end date window 406, a calendar window 408, an energy consumption display window 410, a reset button 412, and a unit selection slider button 414. The input/output features 404 through 412 function as explained above.

However, note that when the slider 414 is moved (e.g., by user contact with the touch-screen enabled user interface) to an energy unit position (lightning bolt symbol), the accrued energy consumption window 410 displays accrued energy consumption in kWh. View 402 shows 32.8 kWh, by way of example only, meaning that the total accumulated energy between the start date and the end date for the given appliance/task/home that is being analyzed was 32.8 kWh.

But when the slider button 414 is moved to a cost unit position (dollar symbol), the window 410 displays accrued energy consumption in terms of cost. View 416 shows cost accrued between the start date and end date. By way of example only, window 410 shows an accumulated cost of $15.35, which corresponds to the 32.8 kWh that was consumed over the selected time range. Note that the database, mentioned above, maintains the cumulative cost with 1 hour resolution, which may change depending on the rates charged by the given utility company supplying the energy at the time the energy in question was supplied.

Note that the user interfaces of FIGS. 2 and 4 could be combined so that one user interface with all the user input and output features described are presented on one display screen. Alternately, less features and/or other features not expressly shown can be implemented on the user interface.

Thus, while there have been shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A resource consumption user interface comprising:
one or more user input features for selecting a start date and an end date for defining a selected time range over which to determine resource consumption associated with at least one resource consumption task from a plurality of resource consumption tasks that contribute to a total resource consumption in a given environment, wherein the plurality of resource consumption tasks are associated with one or more appliances that operate in the given environment and wherein the start date and the end date are selectable for any desired time range over a given time duration; and
one or more user output features for presenting information associated with the at least one resource consumption task, wherein the presented information represents accumulated information beginning at a time on the selected start date and ending at a time on the selected end date.

2. The resource consumption user interface of claim 1, wherein the information presented comprises a resource consumption value represented in one of a resource unit and a cost unit.

3. The resource consumption user interface of claim 2, further comprising a resource consumption unit selection feature for selecting whether the accumulated information is presented in the resource unit or the cost unit.

4. The resource consumption user interface of claim 1, wherein the one or more user input features and the one or more user output features are implemented in accordance with one or more of a display, an appliance, a thermostat, and a computing device.

5. The resource consumption user interface of claim 1, wherein the information presented is derived from at least one database that maintains resource consumption information associated with the one or more appliances that operate in the given environment.

6. The resource consumption user interface of claim 1, wherein the given environment comprises a home environment.

7. The resource consumption user interface of claim 1, wherein the one or more user output features comprise a calendar feature for selecting the start date and the end date, and for displaying the selected start date and the selected end date.

8. The resource consumption user interface of claim 7, wherein the selected time range defined by the selected start time and the selected end time is highlighted on the calendar feature.

9. The resource consumption user interface of claim 1, wherein the resource comprises an energy resource.

10. The resource consumption user interface of claim 9, wherein the energy resource comprises one of electricity and natural gas.

11. The resource consumption user interface of claim 1, wherein the resource comprises water.

12. A resource consumption system comprising:
a user interface comprising: (i) one or more user input features for selecting a start date and an end date for defining a selected time range over which to determine resource consumption associated with at least one resource consumption task from a plurality of resource consumption tasks that contribute to a total resource consumption in a given environment, wherein the plurality of resource consumption tasks are associated with one or more appliances that operate in the given environment and wherein the start date and the end date are selectable for any desired time range over a given time duration; and (ii) one or more user output features for presenting information associated with the at least one resource consumption task, wherein the presented information represents accumulated information beginning at a time on the selected start date and ending at a time on the selected end date; and
a controller coupled to the user interface and configured to: (i) receive one or more selections from the one or more user input features; and (ii) in response thereto, provide the information to the one or more user output features for presentation.

13. The resource consumption system of claim 12, wherein the controller is further configured to obtain, from at least one database, resource consumption information associated with the one or more appliances that operate in the given environment.

14. The resource consumption system of claim 12, wherein the controller is further configured to calculate accumulated resource consumption in terms of at least one of a resource unit and a cost unit.

15. The resource consumption system of claim 12, wherein the controller computes an accumulated resource usage value as a difference between a resource usage at the time on the selected end date and a resource usage at the time on the selected start date.

16. The resource consumption system of claim 12, wherein the controller computes an accumulated resource cost value as a difference between a resource cost at the time on the selected end date and a resource cost at the time on the selected start date.

17. The resource consumption system of claim 12, wherein the user interface is implemented in accordance with one or more of a display, an appliance, a thermostat, and a computing device.

18. The resource consumption system of claim 12, wherein the resource comprises an energy resource.

19. The resource consumption system of claim 18, wherein the energy resource comprises one of electricity and natural gas.

20. The resource consumption system of claim 12, wherein the resource comprises water.
